(19) United States
(12) Patent Application Publication
(10) Pub. No.: US 2015/0296604 A1
(43) Pub. Date: Oct. 15, 2015

(54) EXTREME ULTRAVIOLET LIGHT GENERATION SYSTEM AND EXTREME ULTRAVIOLET LIGHT GENERATION APPARATUS

(71) Applicant: GIGAPHOTON INC., Tochigi (JP)

(72) Inventors: Shinji NAGAI, Tochigi (JP); Takashi SAITO, Tochigi (JP)

(21) Appl. No.: 14/729,723

(22) Filed: Jun. 3, 2015

Related U.S. Application Data
(63) Continuation of application No. PCT/JP2013/084082, filed on Dec. 19, 2013.

(30) Foreign Application Priority Data
Dec. 20, 2012 (JP) 2012-278197

(51) Int. Cl. H05G 2/00

(52) U.S. Cl. CPC H05G 2/008; H05G 2/003

(57) ABSTRACT

An extreme ultraviolet light generation system may include a beam focusing optics configured such that a pre-pulse laser beam and a main pulse laser beam are focused on a plasma generation region, and that a beam path axis of the pre-pulse laser beam and a beam path axis of the main pulse laser beam pass through the plasma generation region at an angle equal to or smaller than a loss-cone angle with respect to a central axis of a magnetic field that is generated by a magnetic field generator. A first laser apparatus and a second laser apparatus may be controlled such that, after a target outputted from a target generation unit has been irradiated with the pre-pulse laser beam in the plasma generation region, the target is irradiated with the main pulse laser beam with a delay time ranging from 0.5 μs or longer to 7 μs or shorter.

### TECHNICAL FIELD

The present disclosure relates to an extreme ultraviolet light generation system and an extreme ultraviolet light generation apparatus.

### BACKGROUND ART

In recent years, as semiconductor processes become finer, transfer patterns for use in photolithographies of semiconductor processes have rapidly become finer. In the next generation, microfabrication at 70 nm to 45 nm, further, microfabrication at 32 nm or less will be demanded. In order to meet the demand for microfabrication at 32 nm or less, for example, the development of an exposure apparatus in which an apparatus for generating EUV (extreme ultraviolet) light at a wavelength of approximately 13 nm is combined with a reduced projection reflective optics is expected.

Three types of extreme ultraviolet light generation apparatuses have been proposed, which include an LPP (laser produced plasma) type system using plasma generated by irradiating a target with a laser beam, a DPP (discharge produced plasma) type system using plasma generated by electric discharge, and an SR (synchrotron radiation) type system using orbital radiation.

### SUMMARY

An extreme ultraviolet light generation system according to one aspect of the present disclosure may include: a first laser apparatus; a second laser apparatus; a chamber having a through-hole through which a pre-pulse laser beam outputted from the first laser apparatus and a main pulse laser beam outputted from the second laser apparatus pass; a magnetic field generator configured to generate a magnetic field in a region including a plasma generation region inside the chamber; a beam focusing optics configured such that the pre-pulse laser beam and the main pulse laser beam are focused on the plasma generation region, and that a beam path axis of the pre-pulse laser beam and a beam path axis of the main pulse laser beam pass through the plasma generation region at an angle equal to or smaller than a loss-cone angle with respect to a central axis of the magnetic field that is generated by the magnetic field generator; a target generation unit; and an EUV light generation controller configured to control the first laser apparatus and the second laser apparatus such that, after a target outputted from the target generation unit has been irradiated with the pre-pulse laser beam in the plasma generation region, the target is irradiated with the main pulse laser beam with a delay time ranging from 0.5 μs or longer to 7 μs or shorter.

An extreme ultraviolet light generation apparatus according to another aspect of the present disclosure may include: a chamber having a through-hole through which a pulse laser beam passes; a beam focusing optics configured such that the pulse laser beam is focused on a plasma generation region inside the chamber; a target generation unit configured to output a target toward the plasma generation region; a magnetic field generator configured to generate a magnetic field in a region including the plasma generation region; and an ion collector located between the plasma generation region and the magnetic field generator, configured to collect ions generated in the plasma generation region, and that defines a laser beam passageway through which the pulse laser beam passes.

An extreme ultraviolet light generation apparatus according to another aspect of the present disclosure may include: a chamber having a through-hole through which a pre-pulse laser beam outputted from a first laser apparatus and a main pulse laser beam outputted from a second laser apparatus pass; a magnetic field generator configured to generate a magnetic field in a region including a plasma generation region inside the chamber; a target generation unit; a beam combiner configured to combine the pre-pulse laser beam and the main pulse laser beam; a beam focusing optics configured such that the pre-pulse laser beam and the main pulse laser beam outputted from the beam combiner are focused on the plasma generation region in such a manner as to intersect with a central axis of the magnetic field that is generated by the magnetic field generator; and an EUV collector mirror having a reflective surface facing a surface including beam path axes of the pre-pulse laser beam and the main pulse laser beam and the central axis of the magnetic field that is generated by the magnetic field generator, the EUV collector mirror being configured to collect extreme ultraviolet light generated in the plasma generation region.

### BRIEF DESCRIPTION OF DRAWINGS

Hereinafter, selected embodiments of the present disclosure will be described with reference to the accompanying drawings by way of example.

FIG. 1 schematically illustrates a configuration example of an LPP type EUV light generation system.

FIG. 2A is a partial cross-sectional view showing a configuration of the EUV light generation system according to a first embodiment.

FIG. 2B illustrates a cross-section, which is parallel to a ZX plane, of the EUV light generation apparatus shown in FIG. 2A.

FIG. 3 is a graph showing a result of measurement of a relationship between an irradiation condition of the pre-pulse laser beam and the main pulse laser beam and CE in the EUV light generation system.

FIG. 4 is a diagram for explaining a loss-cone angle.

FIG. 5A shows a result of measurement of a distribution of charge amounts of positive ions generated when a target was irradiated with the pre-pulse laser beam and the main pulse laser beam.

FIG. 5B shows a plane of polar coordinates of the distribution of ion charge amounts shown in FIG. 5A.

FIG. 6 is a partial cross-sectional view of an EUV light generation apparatus according to a second embodiment.

FIGS. 7A and 7B illustrate in detail a configuration of an ion collector shown in FIG. 6.

FIG. 8 is a partial cross-sectional view of an EUV light generation apparatus according to a third embodiment.

FIG. 9A is a partial cross-sectional view of an EUV light generation system according to a fourth embodiment.

FIG. 9B illustrates a cross-section, which is parallel to a ZX plane, of the EUV light generation apparatus shown in FIG. 9A.

FIG. 10 schematically illustrates a range A of convergence of ions by a magnetic field.

FIG. 11 is a block diagram of a first laser apparatus that can be used in each of the EUV light generation apparatuses according to the aforementioned respective embodiments.

FIG. 12 shows a plane of polar coordinates of a result of measurement of a light intensity distribution of EUV light emitted from plasma.

### DESCRIPTION OF EMBODIMENTS

### Contents

### 1. Overview

2. Description of terms
3. Overview of the EUV light generation system

3.1 Configuration

3.2 Operation

4. EUV light generation apparatus including a magnetic field generator (first embodiment)

4.1 Configuration

4.2 Operation

4.3 Regarding the fifth delay time

4.4 Loss-cone angle

4.5 Improvement of the ion collection rate

5. Second embodiment (case where a laser beam path axis coincides with a magnetic field axis)
6. Third embodiment (case where a magnetic field is asymmetrical)
7. Fourth embodiment (case where a laser beam path axis and a magnetic field axis are orthogonal to each other)
8. Others (first laser apparatus)

Hereinafter, selected embodiments of the present disclosure will be described in detail with reference to the accompanying drawings. The embodiments to be described below are merely illustrative in nature and do not limit the scope of the present disclosure. Further, the configuration(s) and operation(s) described in each embodiment are not all essential in implementing the present disclosure. Corresponding elements may be referenced by corresponding reference numerals and characters, and duplicate descriptions thereof may be omitted.

### 1. Overview

In an LPP type EUV light generation apparatus, a target generation unit may output a target so that the target may reach a plasma generation region located within a chamber. By a laser system irradiating the target with a pulse laser beam when the target reaches the plasma generation region, the target may be turned into plasma and EUV light may be emitted from the plasma.

The plasma may contain ions and electrons generated by the ionization of a target material. If the ions contained in the plasma adhere to an optical device disposed within the chamber, the ions may degrade the performance of the optical device. In order to collect such ions, a magnetic field may be generated in a region including the plasma generation region by a magnetic field generator.

Ions released and diffused from the plasma generation region may have their direction of movement changed under the Lorentz force exerted by the magnetic field, and may move spirally along the magnetic field. Ions released from the plasma generation region into directions within a range of angles equal to or smaller than an angle called a loss-cone angle with respect to the magnetic field may be collected by an ion collector provided between the plasma generation region and the magnetic field generator. However, ions released in directions at angles larger than the loss-cone angle with respect to the magnetic field may be confined to the magnetic field, and may not be able to reach the ion collector. The ions that were not able to reach the ion collector may adhere to the optical device disposed within the chamber.

The inventors of the present invention found that a distribution of the amounts of ions contained in the plasma may depend on the direction of irradiation of the pulse laser beam with which the target is irradiated. If a large number of ions are released at angles equal to or smaller than the loss-cone angle with respect to the magnetic field, a large number of ions may reach the ion collector, and efficient collection may be achieved. On the other hand, if a large number of ions are released at angles larger than the loss-cone angle with respect to the magnetic field, efficiency in the collection of ions may be decreased.

According to one aspect of the present disclosure, a beam path axis of the pulse laser beam with which the target is irradiated may pass through the plasma generation region at an angle equal to or smaller than the loss-cone angle with respect to a central axis of the magnetic field.

According to another aspect of the present disclosure, an ion collector that allows passage of the pulse laser beam may be provided between the plasma generation region and one of the magnetic field generators.

According to these aspects, a large number of ions may be released at angles equal to or smaller than the loss-cone angle with respect to the magnetic field, and may be efficiently collected by the ion collector.

Further, even if a large number of ions are released at angles larger than the loss-cone angle with respect to the magnetic field, the ions may be restrained from adhering to the EUV collector mirror in a case where the direction of release is not a direction toward the EUV collector mirror.

According to another aspect of the present disclosure, a surface including the beam path axis of the pulse laser beam with which the target is irradiated and the central axis of the magnetic field and a reflective surface of the EUV collector mirror may face each other.

According to this aspect, ions released at angles larger than the loss-cone angle with respect to the magnetic field may be restrained from reaching the EUV collector mirror.

### 2. Description of terms

Several terms used in the present disclosure will be described hereinafter.

“Loss-cone angle” may refer to such a threshold value for a direction of movement of ions at which the ions are emitted along a magnetic field without being confined to the magnetic field. As used in the field of nuclear fusion reactors and the like in which ions confined to a magnetic field are utilized, the term “loss cone” may be derived from the conical shape of a range of directions of movement of ions that are lost without being confined to a magnetic field.

A “trajectory” of a target may be an ideal path of a target outputted from a target generation unit, or may be a path of a target according to the design of a target generation unit.

An “actual path” of a target may be a path of a target which is actually outputted from the target generation unit.

“Plasma generation region” may refer to a region where the generation of plasma for generating EUV light begins. In order for the generation of plasma to begin at the plasma generation region, it may be necessary for a target to be supplied to the plasma generation region and for a pulse laser beam to be focused on the plasma generation region at the timing when the target reaches the plasma generation region.

### 3. Overview of the EUV Light Generation System

### 3.1 Configuration

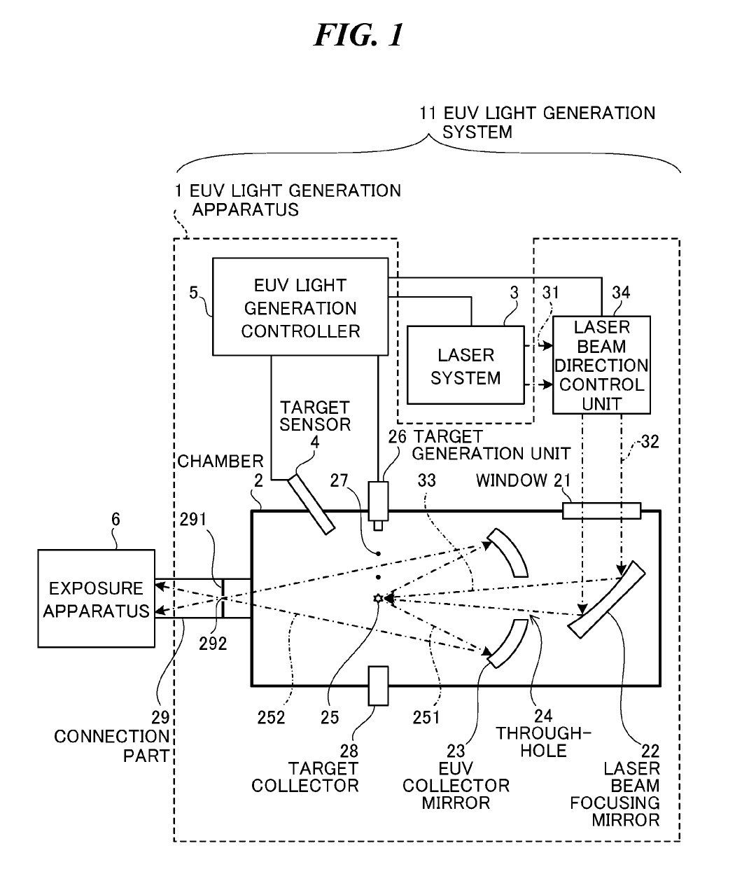

FIG. 1 schematically illustrates a configuration example of an LPP type EUV light generation system. An EUV light generation apparatus 1 may be used with at least one laser system 3. Hereinafter, a system that includes the EUV light generation apparatus 1 and the laser system 3 may be referred to as an EUV light generation system 11. As shown in FIG. 1 and described in detail below, the EUV light generation apparatus 1 may include a chamber 2 and a target generation unit 26. The chamber 2 may be sealed airtight. The target generation unit 26 may be mounted onto the chamber 2, for example, to penetrate a wall of the chamber 2. A target material to be supplied by the target generation unit 26 may include, but is not limited to, tin, terbium, gadolinium, lithium, xenon, or a combination of any two or more of them.

The chamber 2 may have at least one through-hole in its wall. A window 21 may be located at the through-hole. A pulse laser beam 32 that is outputted from the laser system 3 may travel through the window 21. In the chamber 2, an EUV collector mirror 23 having a spheroidal reflective surface may be provided. The EUV collector mirror 23 may have a first focusing point and a second focusing point. The reflective surface of the EUV collector mirror 23 may have a multi-layered reflective film in which molybdenum layers and silicon layers are alternately laminated, for example. The EUV collector mirror 23 may be arranged, for example, such that the first focusing point is positioned in a plasma generation region 25 and the second focusing point is positioned in an intermediate focus (IF) region 292. If necessary, the EUV collector mirror 23 may have a through-hole 24 formed at the center thereof so that a pulse laser beam 33 may travel through the through-hole 24.

The EUV light generation apparatus 1 may include an EUV light generation controller 5 and a target sensor 4. The target sensor 4 may have an imaging function, and may be configured to detect at least one of the presence, actual path, position and speed of a target 27.

Further, the EUV light generation apparatus 1 may include a connection part 29 for allowing the interior of the chamber 2 to be in communication with the interior of the exposure apparatus 6. In the connection part 29, a wall 291 having an aperture may be provided. The wall 291 may be positioned such that the second focusing point of the EUV collector mirror 23 lies in the aperture formed in the wall 291.

The EUV light generation apparatus 1 may also include a laser beam direction control unit 34, a laser beam focusing mirror 22, and a target collector 28 for collecting the target 27. The laser beam direction control unit 34 may include an optical element (not separately shown) for defining the direction of the laser beam and an actuator (not separately shown) for adjusting the position or the posture of the optical element.

### 3.2 Operation

With continued reference to FIG. 1, a pulse laser beam 31 outputted from the laser system 3 may pass through the laser beam direction control unit 34 and be outputted therefrom as the pulse laser beam 32 to travel through the window 21 and enter into the chamber 2. The pulse laser beam 32 may travel inside the chamber 2 along at least one beam path, be reflected by the laser beam focusing mirror 22, and strike at least one target 27 as a pulse laser beam 33.

The target generation unit 26 may be configured to output the target(s) 27 toward the plasma generation region 25 in the chamber 2. The target 27 may be irradiated with at least one pulse of the pulse laser beam 33. Upon being irradiated with the pulse laser beam, the target 27 may be turned into plasma, and rays of light 251 may be emitted from the plasma. EUV light included in the light 251 may be reflected by the EUV collector mirror 23 at a higher reflectance than light included in another wavelength region. The reflected light 252 including the EUV light reflected by the EUV collector mirror 23 may be focused on the intermediate focus region 292 and outputted to the exposure apparatus 6. Alternatively, the target 27 may be irradiated with multiple pulses included in the pulse laser beam 33.

The EUV light generation controller 5 may be configured to integrally control the EUV light generation system 11. The EUV light generation controller 5 may be configured to process image data, and the like, of the target 27 captured by the target sensor 4. Further, the EUV light generation controller 5 may be configured to control at least one of: the timing when the target 27 is outputted; and the direction to which the target 27 is outputted. Furthermore, the EUV light generation controller 5 may be configured to control at least one of: the timing when the laser system 3 oscillates; the direction in which the pulse laser beam 32 travels; and the position at which the pulse laser beam 33 is focused. The various controls mentioned above are merely examples, and other controls may be added as necessary.

### 4. Extreme Ultraviolet Light Generation Apparatus Including a Magnetic Field Generator

### 4.1 Configuration

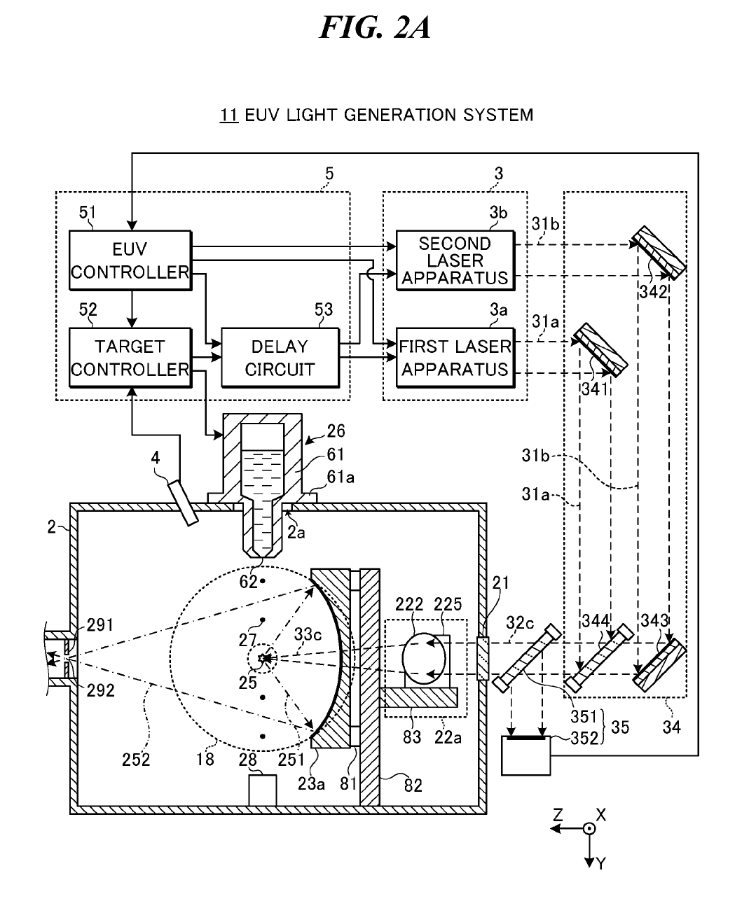

FIG. 2A is a partial cross-sectional view showing a configuration of the EUV light generation system 11 according to a first embodiment. FIG. 2A illustrates a cross-section, which is parallel to a YZ plane, of an EUV light generation apparatus 1. FIG. 2B illustrates a cross-section, which is parallel to a ZX plane, of the EUV light generation apparatus shown in FIG. 2A. An X direction may correspond to a direction in which a central axis 18b of a magnetic field 18a extends. A Y direction may correspond to a direction in which a target 27 travels and, preferably, a direction of gravitational force. A Z direction may correspond to a direction in which a central axis of reflected light 252 including EUV light extends. The X direction, the Y direction, and the Z direction may be perpendicular to one another. As shown in FIGS. 2A and 2B, a beam focusing optics 22a, the EUV collector mirror 23a, a target collector 28, an ion collector 28a, an EUV collector mirror holder 81, and plates 82 and 83 may be provided inside the chamber 2. The target generation unit 26 may be attached to the chamber 2.

The laser beam direction control unit 34, a beam detector 35, the EUV light generation controller 5, and a magnetic field generator 18 may be provided outside the chamber 2. The laser beam direction control unit 34 may include high reflection mirrors 341, 342 and 343 and a dichroic mirror 344. The beam detector 35 may include a beam splitter 351 and an optical sensor 352. The EUV light generation controller 5 may include the EUV controller 51, the target controller 52, and a delay circuit 53.

The laser system 3 constituting the EUV light generation system may be further provided outside the chamber 2. The laser system 3 may include a first laser apparatus 3a and a second laser apparatus 3b. The first laser apparatus 3a may output a pre-pulse laser beam 31a. The second laser apparatus 3b may output a main pulse laser beam 31b.

The plate 82 may be fixed to the chamber 2, and the plate 83 may be fixed to the plate 82. The EUV collector mirror 23a may be fixed to the plate 82 via the EUV collector mirror holder 81. The EUV collector mirror 23a does not need to have the through-hole 24 (FIG. 1).

The beam focusing optics 22a may include a flat mirror 221, an off-axis paraboloidal mirror 222, a flat mirror 223, and holders 224 to 226. The flat mirror 221 may be held by the holder 224. The off-axis paraboloidal mirror 222 may be held by the holder 225. The flat mirror 223 may be held by the holder 226. The holders 224 and 225 may be fixed to the plate 83. The holder 226 may be fixed to the chamber 2. The positions and the postures of the flat mirror 221, the off-axis paraboloidal mirror 222, and the flat mirror 223 may be held so that a combination 33c of the pre-pulse laser beam and the main pulse laser beam reflected by these mirrors is focused on the plasma generation region 25.

The target generation unit 26 may include a reservoir 61. The reservoir 61 may hold a target material in a melted state in its interior by using a heater (not shown). Part of the reservoir 61 may be inserted into a through-hole 2a formed in a wall of the chamber 2 so that a leading end of the reservoir 61 is positioned inside the chamber 2. An opening 62 may be formed at the leading end of the reservoir 61. A flange portion 61a of the reservoir 61 may be fixed in close contact with the wall of the chamber 2 that surrounds the through-hole 2a.

The magnetic field generator 18 may include a pair of magnets. Each of these magnets may be an electromagnet including a toroidal coil connected to a power supply 19. The magnetic field generator 18 may be disposed so that central axes of these coils are substantially orthogonal to the direction in which a target 27 travels. The magnetic field generator 18 may be configured to generate the magnetic field 18a inside the chamber 2. The central axes of the two coils in the magnetic field generator 18 may coincide substantially with the central axis 18b of the magnetic field 18a. The magnetic field 18a may be axisymmetrical about the central axis 18b. It is preferable that the magnetic field 18a be generated in a region including the plasma generation region 25.

### 4.2 Operation

With reference to FIG. 2A, the target generation unit 26 may output the melted target material as a droplet target 27 toward the plasma generation region 25 inside the chamber 2 via the opening 62. The target collector 28 may be disposed on the extension line of the trajectory of the target 27, and may collect the target 27 having passed through the plasma generation region 25.

The high reflection mirror 341 in the laser beam direction control unit 34 may be provided in a beam path of the pre-pulse laser beam 31a that is outputted by the first laser apparatus 3a. The high reflection mirror 341 may reflect the pre-pulse laser beam 31a at high reflectance.

The pre-pulse laser beam 31a reflected by the high reflection mirror 341 may be incident on the dichroic mirror 344 from the upper side in the drawing. The dichroic mirror 344 may reflect the pre-pulse laser beam 31a at high reflectance toward the left side in the drawing.

The main pulse laser beam 31b that is outputted by the second laser apparatus 3b may contain a wavelength component that is different from a wavelength component contained in the pre-pulse laser beam 31a. The high reflection mirrors 342 and 343 may be provided in a beam path of the main pulse laser beam 31b. The high reflection mirrors 342 and 343 may reflect the main pulse laser beam 31b in sequence at high reflectance.

The main pulse laser beam 31b reflected by the high reflection mirrors 342 and 343 may be incident on the dichroic mirror 344 from the right side in the drawing. The dichroic mirror 344 may transmit the main pulse laser beam 31b at high transmittance toward the left side in the drawing.

This allows the pre-pulse laser beam 31a and the main pulse laser beam 31b to be combined by the dichroic mirror 344. That is, the dichroic mirror 344 may function as a beam combiner. A combination 32c of the pre-pulse laser beam and the main pulse laser beam may be guided to the beam focusing optics 22a.

With reference to FIG. 2B, the flat mirror 221 in the beam focusing optics 22a may be provided in a beam path of the combination 32c of the pre-pulse laser beam and the main pulse laser beam. The flat mirror 221 may reflect the combination 32c of the pre-pulse laser beam and the main pulse laser beam toward the off-axis paraboloidal mirror 222. The flat mirror 221 and the off-axis paraboloidal mirror 222 may be disposed in a position behind a reflective surface of the EUV collector mirror 23a. The term “behind” may mean a direction from the reflective surface of the EUV collector mirror 23a toward a surface of the EUV collector mirror 23a opposite to the reflective surface.

The flat mirror 223 may be provided in a beam path of the combination 33c of the pre-pulse laser beam and the main pulse laser beam reflected by the off-axis paraboloidal mirror 222. The flat mirror 223 may be disposed in a position in front of the reflective surface of the EUV collector mirror 23a. The term “in front of” may mean a direction from the surface of the EUV collector mirror 23a opposite to the reflective surface toward the reflective surface of the EUV collector mirror 23a. The combination 33c of the pre-pulse laser beam and the main pulse laser beam reflected by the off-axis paraboloidal mirror 222 may travel through an optical path outside an outer edge of the reflective surface of the EUV collector mirror 23a to reach the flat mirror 223. Note that FIG. 2A omits to show the flat mirror 223.

The flat mirror 223 may reflect the combination 33c of the pre-pulse laser beam and the main pulse laser beam and thereby guide these beams to the plasma generation region 25. The orientation of a beam path axis 33a of the pre-pulse laser beam passing through the plasma generation region 25 and the orientation of a beam path axis 33b of the main pulse laser beam passing through the plasma generation region 25 may be slightly different from the orientation of the central axis 18b of the magnetic field 18a that is generated by the magnetic field generator 18. The position of the flat mirror 223 may be a position that does not overlap the ion collector 28a as seen from the plasma generation region 25.

With reference to FIG. 2A, the beam detector 35 may be disposed between the laser beam direction control unit 34 and the beam focusing optics 22a. The beam splitter 351 in the beam detector 35 may transmit the combination 32c of the pre-pulse laser beam and the main pulse laser beam at high transmittance toward the beam focusing optics 22a. At the same time, the beam splitter 351 may reflect a part of the combination 32c of the pre-pulse laser beam and the main pulse laser beam toward the optical sensor 352. The optical sensor 352 may receive that part of the combination 32c of the pre-pulse laser beam and the main pulse laser beam which has been reflected by the beam splitter 351. The optical sensor 352 may output, to the EUV light generation controller 5, a light reception timing signal representing timing at which the part was received.

In a case where an EUV light generation command signal has been outputted from the exposure apparatus 6 (FIG. 1), the EUV controller 51 in the EUV light generation controller 5 may receive the EUV light generation command signal. The EUV light generation controller 5 may have either of the first and second functions described below. The EUV light generation command signal may be a trigger signal that is sent from the exposure apparatus 6 to the EUV light generation controller 5.

The first function may be as follows:

The EUV controller 51 may output a target generation signal to the target controller 52 in accordance with the EUV light generation command signal. The target controller 52 may receive the target generation signal from the EUV controller 51 and output it to the target generation unit 26. While the target generation signal is being outputted, the target generation unit 26 may continuously output targets 27 into the chamber 2 at a substantially constant repetition rate.

The target controller 52 may receive a target detection signal having been outputted from the target sensor 4 and representing the timing of detection of a target 27. The target controller 52 may output the target detection signal to the delay circuit 53. The delay circuit 53 may output a first delay signal to the first laser apparatus 3a. The first delay signal may represent timing at which a first delay time has passed from the timing of the target detection signal. The delay circuit 53 may output a second delay signal to the second laser apparatus 3b. The second delay signal may represent timing at which a second delay time has passed from the timing of the target detection signal.

The first delay time may be such a delay time that a target 27 detected by the target sensor 4 is irradiated with the pre-pulse laser beam at the timing when the target 27 reaches the plasma generation region 25. The second delay time may be such a delay time that, at the timing when the target 27 irradiated with the pre-pulse laser beam is diffused to become a predetermined diffused target, the diffused target is irradiated with the main pulse laser beam. The function thus described may be the first function.

The second function may be as follows:

The EUV controller 51 may output an EUV light generation trigger signal to the target controller 52 and the delay circuit 53 in accordance with the EUV light generation command signal. The target controller 52 may receive the EUV light generation trigger signal from the EUV controller 51 and output it to the target generation unit 26. The target generation unit 26 may output a target 27 into the chamber 2 on demand in accordance with the timing of the EUV light generation trigger signal.

The delay circuit 53 may output a third delay signal to the first laser apparatus 3a. The third delay signal may represent timing at which a third delay time has passed from the timing of the EUV light generation trigger signal. The delay circuit 53 may output a fourth delay signal to the second laser apparatus 3b. The fourth delay signal may represent timing at which a fourth delay time has passed from the timing of the EUV light generation trigger signal.

The third delay time may be such a delay time that a target 27 outputted from the target generation unit 26 is irradiated with the pre-pulse laser beam at the timing when the target 27 reaches the plasma generation region 25. The fourth delay time may be such a delay time that, at the timing when the target 27 irradiated with the pre-pulse laser beam is diffused to become a predetermined diffused target, the diffused target is irradiated with the main pulse laser beam. The function thus described may be the second function.

The first and second delay times in the first function or the third and fourth delay times in the second function may be set in accordance with the light reception timing signal outputted from the optical sensor 352 of the beam detector 35. The beam detector 35 may be provided on the beam paths of the pre-pulse laser beam and the main pulse laser beam downstream of the dichroic mirror 344. Therefore, a delay time of the timing of irradiation of a target 27 with the main pulse laser beam from the timing of irradiation of the target 27 with the pre-pulse laser beam may be detected with high accuracy. The delay time of the timing of irradiation of a target 27 with the main pulse laser beam from the timing of irradiation of the target 27 with the pre-pulse laser beam is hereinafter referred to as “fifth delay time.”

### 4.3 Regarding the Fifth Delay Time

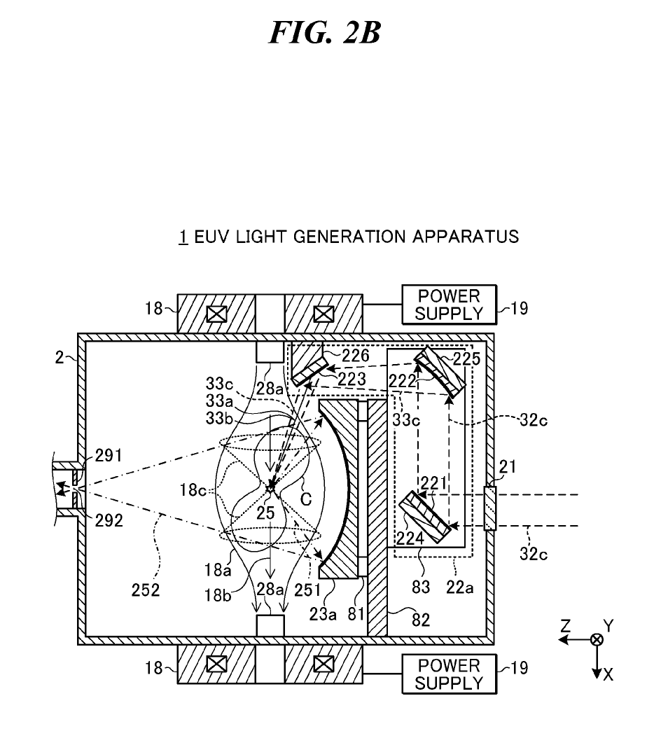

FIG. 3 is a graph showing a result of measurement of a relationship between an irradiation condition of the pre-pulse laser beam 31a and the main pulse laser beam 31b, and conversion efficiency (CE) in the EUV light generation system 11. In FIG. 3, the fifth delay time (μs) is plotted along the horizontal axis, and the conversion efficiency, i.e. CE (s), from energy of the main pulse laser beam into energy of the EUV light is plotted along the vertical axis. In FIG. 3, seven combination patterns of pulse duration (full width at half maximum) and fluence (energy density) of the pre-pulse laser beam were set, and a measurement was carried out on each combination pattern. Obtained results are shown in a line graph. Here, the fluence may be a value in which energy of the pulse laser beam is divided by the area of a circle having a focusing spot diameter. The focusing spot diameter may refer to the diameter of a portion having an intensity equal to or higher than 1/e² of the peak intensity in an intensity distribution of focusing points.

Details of the measurement conditions are as follows. Tin (Sn) was used as the target material, and was melted to generate a droplet target having a diameter of 21 μm.

As the first laser apparatus, an Nd:YAG laser apparatus was used to generate a pre-pulse laser beam having a pulse duration of 10 ns. The wavelength of this pre-pulse laser beam was 1.06 μm and the pulse energy was 0.5 mJ to 2.7 mJ. To generate a pre-pulse laser beam having a pulse duration of 10 ps, a mode-locked laser device including an Nd:YVO₄ crystal was used as the master oscillator, and another laser device including an Nd:YAG crystal was used as the regenerative amplifier. The wavelength of this pre-pulse laser beam was 1.06 μm and the pulse energy thereof was 0.25 mJ to 2 mJ. The focusing spot diameter of each of the pre-pulse laser beams was 70 μm.

As the second laser apparatus, a CO₂ laser apparatus was used to generate a main pulse laser beam. The wavelength of the main pulse laser beam was 10.6 μm and the pulse energy thereof was 135 mJ to 170 mJ. The pulse duration of the main pulse laser beam was 15 ns, and the focusing spot diameter thereof was 300 μm.

Based on the results shown in FIG. 3, when the pulse duration of the pre-pulse laser beam is in the picosecond range and the fluence is 13 J/cm² to 52 J/cm², the fifth delay time may preferably be set as follows: 0.5 μs or more, and 1.8 μs or less; more preferably, 0.7 μs or more, and 1.6 μs or less; or still more preferably, 1.0 μs or more, and 1.4 μs or less.

Further, when the pulse duration of the pre-pulse laser beam is in the nanosecond range and the fluence is 26 J/cm² to 70.2 J/cm², the fifth delay time may preferably be set as follows: 1 μs or more, and 7 μs or less; more preferably, 2 μs or more, and 4 μs or less; or still more preferably, 2.5 μs or more, and 3.5 μs or less.

### 4.4 Loss-Cone Angle

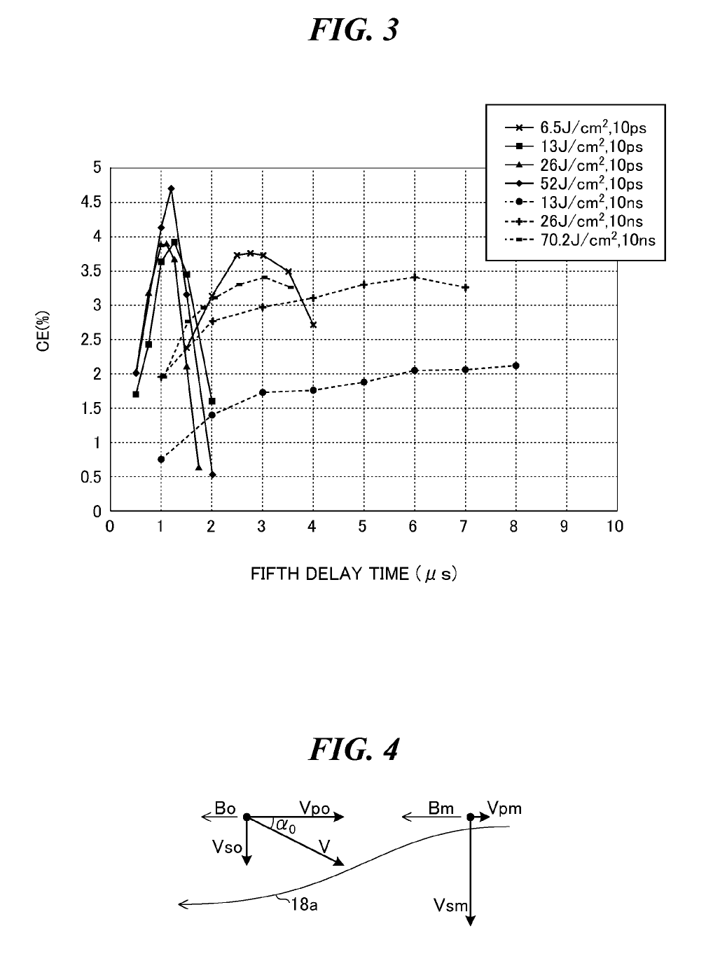

FIG. 4 is a diagram for explaining a loss-cone angle. In the plasma generated in the plasma generation region 25, the ions (cations such as Sn²⁺) of the target material (such as tin) and electrons may be contained. In a case where there is no magnetic field 18a, these ions and electrons may be diffused radially from the plasma generation region 25.

Ions moving while being diffused inside the magnetic field 18a generated by the magnetic field generator 18 may be subject to the Lorentz force. A direction of the Lorentz force may be perpendicular to the direction of lines of magnetic force and to the direction of movement of the ions. As a result, the ions contained in the plasma may have their direction of movement changed under the Lorentz force, move spirally along the lines of magnetic force, and be collected by the ion collector 28a.

This allows the ions to be restrained from scattering toward the EUV collector mirror 23a. Therefore, the EUV collector mirror 23a may be restrained from being contaminated with the ions. However, as will be explained below, not all of the ions are collected by the ion collector 28a.

The magnetic field 18a generated by the magnetic field generator 18 may be weaker in a location away from the magnetic field generator 18 than it may be in a location near the magnetic field generator 18. In a case where two magnetic field generators 18 are disposed with the plasma generation region 25 interposed therebetween, the magnetic field Bₘ in the location near one of the magnetic field generators 18 may be stronger than the magnetic field Bₒ in the location near the plasma generation region 25. That is, Bₒ<Bₘ may hold.

Assume that the velocity of an ion in the vicinity of the plasma generation region 25 contains a velocity component vₚₒ parallel to the magnetic field and a velocity component vₛₒ perpendicular to the magnetic field. Further, assume that the velocity of an ion having moved spirally from an area near the plasma generation region 25 toward an area near the magnetic field generator 18 and reached the area near the magnetic field generator 18 contains a velocity component vₚₘ parallel to the magnetic field and a velocity component vₛₙ perpendicular to the magnetic field. Then, the magnetic moment μ of the ion may be conserved as represented by Expression (1):

$$\begin{matrix}μ = ( m {v}_{so}^{2} / 2 ) / {B}_{o} \\ = ( m {v}_{sm}^{2} / 2 ) / {B}_{m} ,\end{matrix} \qquad Expression ( 1 )$$

where m is the mass of the ion.

As mentioned above, Bₒ<Bₘ holds. Therefore, from Expression (1), vₛₒ<vₛₘ may hold. That is, the spiral movement of an ion from the area near the plasma generation region 25 toward the area near the magnetic field generator 18 causes the magnetic field to become stronger in the place that the ion has reached, so that the velocity component perpendicular to the magnetic field may become larger.

However, since the momentum of the ion is conserved, the absolute value |v| of the velocity of the ion may be constant as represented by Expression (2):

$$\begin{matrix}\vert v \vert = {( {v}_{po}^{2} + {v}_{so}^{2} )}^{1 / 2} \\ = {( {v}_{pm}^{2} + {v}_{sm}^{2} )}^{1 / 2}\end{matrix} \qquad Expression ( 2 )$$

That is, when the velocity component perpendicular to the magnetic field becomes larger, the velocity component parallel to the magnetic field becomes smaller. Therefore, when an ion moves from the area near the plasma generation region 25 toward the area near the magnetic field generator 18 and the magnetic field becomes stronger, the velocity component of the ion parallel to the magnetic field becomes 0 at one place, so that the ion may be returned in a direction toward the plasma generation region 25. For example, assuming that vₚₘ=0, |v|=|vₛₘ| may hold from Expression (2).

Further, assuming that Vₚₘ=0, Expression (3) may be derived as follows:

$$\begin{matrix}sin {α}_{0} = \vert {v}_{so} \vert / \vert v \vert \\ = \vert {v}_{so} \vert / \vert {v}_{sm} \vert ,\end{matrix} \qquad Expression ( 3 )$$

where α₀ is the angle of the direction of movement of an ion in the vicinity of the plasma generation region 25 with respect to the magnetic field.

The angle α₀, which is derived from Expressions (1) and (3) as shown below, is called a loss-cone angle that may indicate such a threshold value of the direction of movement of an ion whose velocity is to be vₚₘ=0.

$$\begin{matrix}{B}_{o} / {B}_{m} = {v}_{so}^{2} / {v}_{sm}^{2} \\ = {sin}^{2} {α}_{0}\end{matrix}$$

$${α}_{0} = {{sin}^{- 1} ( {B}_{o} / {B}_{m} )}^{1 / 2}$$

From the above, ions about to be diffused at angles larger than the loss-cone angle may be reflected by the strong magnetic field Bₘ and returned to the plasma generation region 25 or an area therearound. Ions about to be diffused at angles equal to or smaller than the loss-cone angle may be collected by the ion collector 28a without being reflected by the strong magnetic field Bₘ. A cone whose side surface is a curved surface that is at the angle α₀ with the central axis 18b of the magnetic field 18a is called a loss cone 18c (see FIG. 2B).

### 4.5 Improvement of the Ion Collection Rate

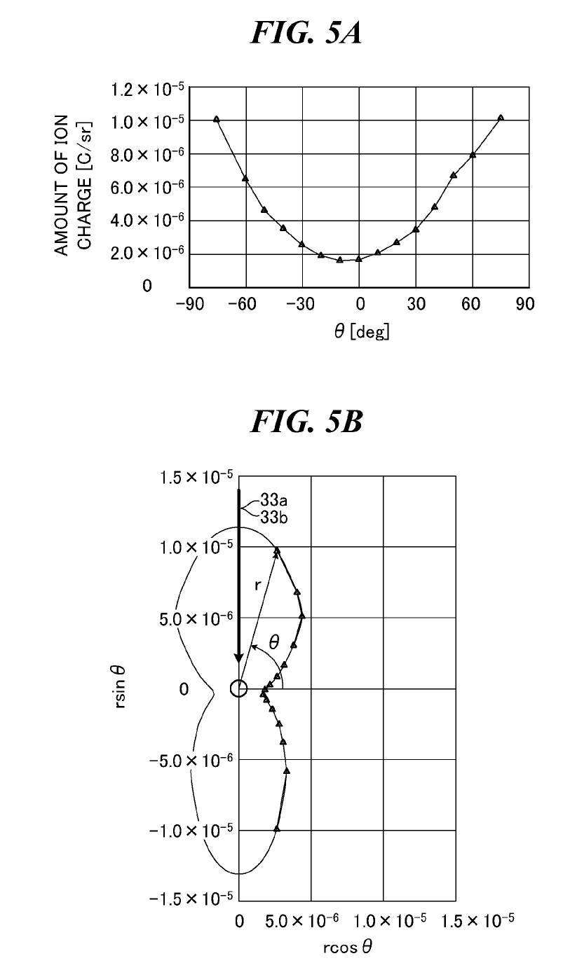

FIG. 5A shows a result of measurement of a distribution of charge amounts of positive ions generated when a target was irradiated with the pre-pulse laser beam and the main pulse laser beam. In FIG. 5A, the horizontal axis represents the angle to the direction perpendicular to the beam path axes 33a and 33b of the pre-pulse laser beam and the main pulse laser beam. The angle θ=90 deg corresponds to the direction of the irradiating side of the pre-pulse laser beam and the main pulse laser beam, i.e., the direction on the upstream side of the beam path of the pre-pulse laser beam and the main pulse laser beam. The angle θ=0 deg corresponds to the direction perpendicular to the beam path axes 33a and 33b of the pre-pulse laser beam and the main pulse laser beam. The angle θ=−90 deg corresponds to the direction of a side opposite to the irradiating side of the pre-pulse laser beam and the main pulse laser beam, i.e., the direction on the downstream side of the beam path of the pre-pulse laser beam and the main pulse laser beam. In FIG. 5A, the vertical axis represents the amount of ion charge per steradian at each angle.

FIG. 5A shows a result of measurement performed in a state where the magnetic field generator 18 is shut off from the power supply 19. Used as a target was liquid tin (Sn) having a diameter of 20 μm. The pre-pulse laser beam had a wavelength of 1.06 μm, a pulse duration of 10 ns, a pulse energy of 2.6 mJ, and a spot diameter of 70 μm. The main pulse laser beam had a wavelength of 10.6 μm, a pulse duration of 15 ns, a pulse energy of 170 mJ, and a spot diameter of 300 μm. The fifth delay time was 3 μs. The aforementioned “spot diameter” is the diameter of a portion having an intensity equal to or higher than 1/e² of the peak intensity in the position at which the pulse laser beam is focused.

As shown in FIG. 5A, the ions were not isotropically generated. More of the ions were distributed in two directions parallel to the beam path axes 33a and 33b of the pre-pulse laser beam and the main pulse laser beam with which the target 27 is irradiated, and less of the ions were distributed in a direction perpendicular to the beam path axes.

FIG. 5B shows a plane of polar coordinates of the distribution of ion charge amounts shown in FIG. 5A. The angle θ to the horizontal direction in FIG. 5B corresponds to the value represented by the horizontal axis in FIG. 5A. The distance r from the origin in FIG. 5B corresponds to the value represented by the vertical axis in FIG. 5A. The distribution of ion charge amounts may be axisymmetrical about the beam path axes 33a and 33b of the pre-pulse laser beam and the main pulse laser beam. That is, when represented in a space of polar coordinates, the distribution of ion charge amounts may be in the shape of a curved surface obtained by a trajectory of rotation, about a straight line of θ=90 deg, of a curve representing a right-half distribution shown in FIG. 5B. Moreover, the shape of the curved surface may correspond to the surface shape of a “gourd-shaped” rotating body including two spheroids joined to each other.

FIG. 2B shows a curve C representing a distribution of ion charge amounts in each direction centered at the plasma generation region 25. The shape of the curve C corresponds to the shape of the curve representing the distribution of ion charge amounts shown in FIG. 5B. That is, in FIG. 2B, the longer the distance from the plasma generation region 25 to each point on the curve C is, the larger the ion charge amount is in a direction toward the point. As shown in FIG. 2B, in a case where a portion of the curve C that indicates a large ion charge amount is located within the loss cone 18c of the magnetic field, many of the ions generated in the plasma generation region 25 may be collected by the ion collector 28a. In the present embodiment, the beam focusing optics 22a is disposed so that the beam path axis 33a of the pre-pulse laser beam and the beam path axis 33b of the main pulse laser beam pass through the plasma generation region 25 at an angle equal to or smaller than the loss-cone angle with respect to the central axis 18b of the magnetic field. With this, a portion of the curve C that indicates a large ion charge amount is located within the loss cone 18c of the magnetic field, so that many of the ions generated in the plasma generation region 25 may be collected by the ion collector 28a.

### 5. Second Embodiment

### Case where a Laser Beam Path Axis Coincides with a Magnetic Field Axis

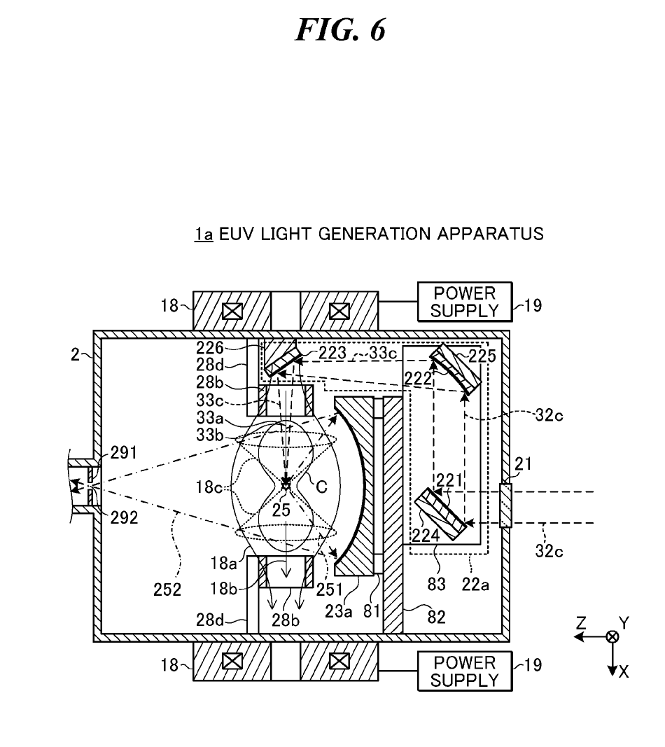

FIG. 6 is a partial cross-sectional view of an EUV light generation apparatus 1a according to a second embodiment. In the second embodiment, the flat mirror 223 may be located on the central axis 18b of the magnetic field 18a. This may cause the beam path axis 33a of the pre-pulse laser beam and the beam path axis 33b of the main pulse laser beam to extend in substantially the same direction as the central axis 18b of the magnetic field 18a. Two ion collectors 28b each having a cylindrical shape may be supported by a support member 28d in the chamber 2. One of the ion collectors 28b may be provided between the flat mirror 223 and the plasma generation region 25. A laser beam passageway through which the combination 33c of the pre-pulse laser beam and the main pulse laser beam passes may be defined by one of the ion collectors 28b having a cylindrical shape.

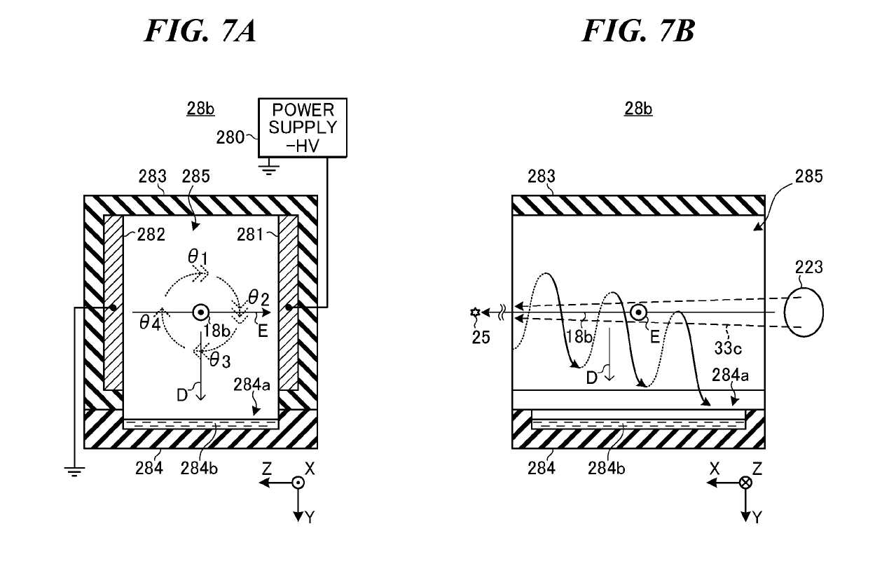

FIGS. 7A and 7B illustrate in detail a configuration of each of the ion collectors 28b shown in FIG. 6. FIG. 7A illustrates the ion collector 28b as seen from the plasma generation region 25, together with the motion of an ion. FIG. 7B illustrates a cross-section, which is parallel to an XY plane, of the ion collector 28b shown in FIG. 7A. The ion collector 28b may include a power supply 280, a pair of electrodes 281 and 282, a holder 283, and a target trapper 284.

The electrode 281 may be electrically connected to an output terminal of the power supply 280, and the electrode 282 may be electrically connected to the ground potential. The pair of electrodes 281 and 282 may be placed opposite to each other. The holder 283 may have electrical insulation and hold the pair of electrodes 281 and 282. The target trapper 284 may be disposed along one end of each of the pair of electrodes 281 and 282. The pair of electrodes 281 and 282, the holder 283, and the target trapper 284 as a whole may form a cylindrical shape to define a cylindrical laser beam passageway 285.

In the laser beam passageway 285, a magnetic field 18a having a central axis 18b may be generated by the magnetic field generator 18. An ion contained in plasma generated in the plasma generation region 25 may move spirally along the magnetic field 18a and reach the space between the pair of electrodes 281 and 282. Assuming that the ion has a positive charge and the central axis 18b of the magnetic field extends in a direction toward the point of view of FIG. 7A, the direction of spiral movement of the ion may be a direction indicated by a clockwise dashed arrow in FIG. 7A. A trajectory of the ion as seen from the point of view of FIG. 7A may be a trajectory of movement, for example, from the position of θ1 to the position of θ2, to the position of θ3, to the position of θ4, and then to the position of θ1.

Here, in a case where the power supply 280 causes a negative potential −HV to be applied to the electrode 281 and an electric field E of a direction from the electrode 282 toward the electrode 281 is generated, an ion having a positive charge may be subject to the Coulomb's force exerted in the same direction as the electric field E. The Coulomb's force may cause the ion to be accelerated in the same direction as the electric field E during the ion travels from the position of θ4 through the position of θ1 to reach the position of θ2. On the other hand, the ion may be decelerated during the ion travels from the position of θ2 through the position of θ3 to reach the position of θ4.

Therefore, among the position of θ1 to θ4, the position θ2 is the position where the velocity component of the ion perpendicular to the central axis 18b of the magnetic field is at its maximum, and θ4 is the position where the velocity component of the ion perpendicular to the central axis 18b of the magnetic field is at its minimum. At the position of θ2, where the velocity component of the ion perpendicular to the central axis 18b of the magnetic field is at its maximum, the Lorentz force, which pulls the ion toward the central axis of the spiral movement, may reach its maximum to surpass the Coulomb's force exerted by the electric field E. As a result of this, the central axis of the spiral movement of the ion may move in the direction of the arrow D perpendicular to both the electric field E and the central axis 18b of the magnetic field. This phenomenon may be called a drift.

Since the central axis of the spiral movement of the ion moves in the direction of the arrow D, the ion may be trapped by the target trapper 284. The target trapper 284 may be heated by a heater (not shown). Ions trapped by the target trapper 284 may be returned to an electrically neutral state, and may be accumulated as a melted target material 284b in a recess 284a. The target material 284b may flow into a pipe (not shown) from the recess 284a and be discharged out of the chamber 2.

The second embodiment makes it possible to align the central axis of a magnetic field and the beam path axis of a laser beam with each other and therefore makes it possible to collect more ions with the ion collector 28b.

The other points may be similar to those of the first embodiment.

In the second embodiment, a case has been described where the combination 33c of the pre-pulse laser beam and the main pulse laser beam is focused on the plasma generation region 25. However, the present disclosure is not limited to such a case. In the second embodiment, the target 27 may be turned into plasma by at least one pulse of the pulse laser beam as described with reference to FIG. 1, without using the pre-pulse laser beam.

### 6. Third Embodiment

### Case where a Magnetic Field is Asymmetrical

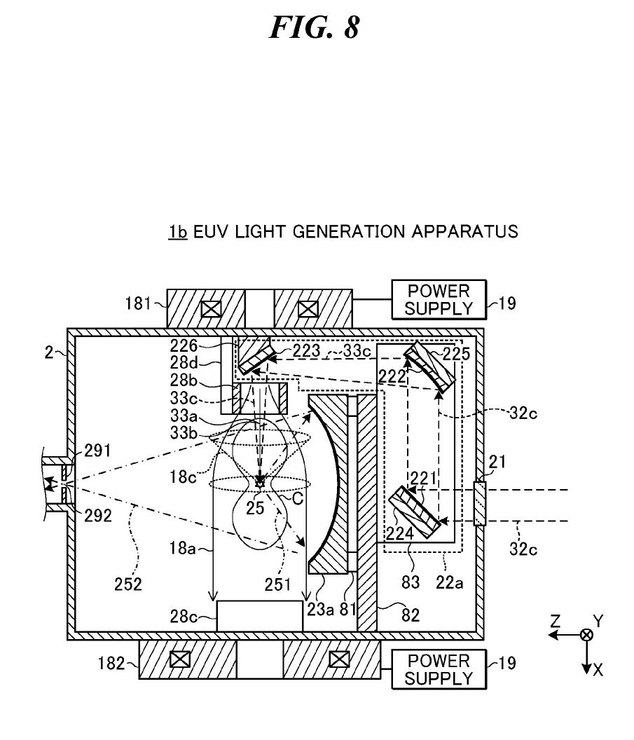

FIG. 8 is a partial cross-sectional view of an EUV light generation apparatus 1b according to a third embodiment. In the third embodiment, a magnetic field that is generated by magnetic field generators may be asymmetrical between the side of one of the magnetic field generators and the side of the other of the magnetic field generators about the plasma generation region 25.

For example, the diameter of the coil in the magnetic field generator 181 may be smaller than the diameter of the coil in the magnetic field generator 182. This may cause lines of magnetic force to be concentrated in a narrow range on the side of the magnetic field generator 181, and may cause lines of magnetic force not to be concentrated on the side of the magnetic field generator 182. This makes it possible to make the magnetic field relatively stronger on the side of the magnetic field generator 181.

Further, even in a case where the diameter of the coil in the magnetic field generator 181 and the diameter of the coil in the magnetic field generator 182 are equal, an asymmetrical magnetic field may be generated by adopting another configuration. For example, the number of turns of the coil in the magnetic field generator 181 may be larger than the number of turns of the coil in the magnetic field generator 182. Alternatively, the value of a current that is passed through the coil in the magnetic field generator 181 may be larger than the value of a current that is passed through the coil in the magnetic field generator 182. This also makes it possible to make the magnetic field stronger on the side of the magnetic field generator 181 than on the side of the magnetic field generator 182.

With this configuration, an ion generated in the plasma generation region 25 may be restrained from being returned toward the plasma generation region 25 in a case where the ion moves toward the magnetic field generator 182, which is weaker in magnetic field. That is, the loss-cone angle on the side of the magnetic field generator 182 may be larger than the loss-cone angle on the side of the magnetic field generator 181. An ion collector 28c having a large-area surface perpendicular to the magnetic field may be provided between the plasma generation region 25 and the magnetic field generator 182, which is weaker in magnetic field.

Preferably, a magnetic field B1 in the ion collector 28b provided on the side of the magnetic field generator 181, a magnetic field B0 in the plasma generation region 25, and a magnetic field B2 in the ion collector 28c provided on the side of the magnetic field generator 182 may have the following relationship:

B1>B0≧B2

This makes it possible to achieve a loss-cone angle of substantially 90 degrees on the side of the magnetic field generator 182.

The third embodiment makes it possible to achieve a loss-cone angle of substantially 90 degrees on the side of the magnetic field generator 182 and therefore makes it possible to collect more ions with the ion collector 28c.

The other points may be similar to those of the second embodiment.

In the third embodiment, a case has been described where the combination 33c of the pre-pulse laser beam and the main pulse laser beam is focused on the plasma generation region 25. However, the present disclosure is not limited to such a case. In the third embodiment, the target 27 may be turned into plasma by at least one pulse of the pulse laser beam as described with reference to FIG. 1, without using the pre-pulse laser beam.

### 7. Fourth Embodiment

### Case where a Laser Beam Path Axis and a Magnetic Field Axis are Orthogonal to Each Other

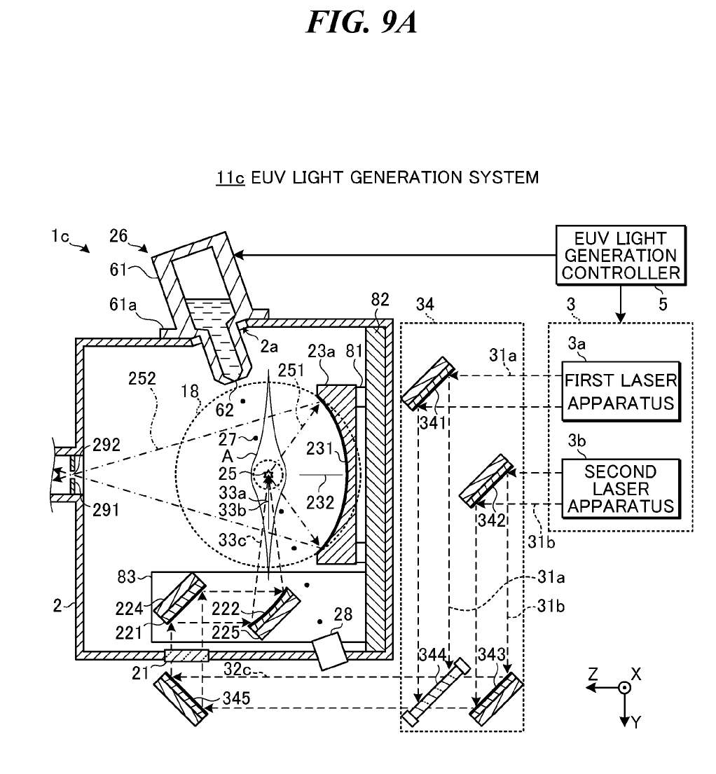

FIG. 9A is a partial cross-sectional view showing a configuration of an EUV light generation system 11c according to a fourth embodiment. FIG. 9A illustrates a cross-section, which is parallel to a YZ plane, of an EUV light generation apparatus 1c. FIG. 9B illustrates a cross-section, which is parallel to a ZX plane, of the EUV light generation apparatus 1c shown in FIG. 9A. In the fourth embodiment, the beam path axis 33a of the pre-pulse laser beam and the beam path axis 33b of the main pulse laser beam may intersect substantially perpendicularly with the central axis 18b of the magnetic field 18a. Moreover, a surface including the beam path axes 33a and 33b and the central axis 18b of the magnetic field 18a and a reflective surface 231 of the EUV collector mirror 23a may be placed opposite to each other.

Further, the surface including the beam path axes 33a and 33b and the central axis 18b of the magnetic field 18a may be substantially perpendicular to a central axis 232 of the EUV collector mirror 23a. Assuming that the reflective surface 231 of the EUV collector mirror 23a is in the shape of a part of a rotating body, the central axis 232 of the EUV collector mirror 23a may be the center of rotation of the rotating body. Further, assuming that the reflective surface 231 of the EUV collector mirror 23a is in the shape of a part of a spheroid, the central axis 232 of the EUV collector mirror 23a may be a line connecting a first focusing point of the spheroid with a second focusing point of the spheroid.

A specific example configuration is described here. A high reflection mirror 345 may be provided in the beam path of the combination 32c of the pre-pulse laser beam and the main pulse laser beam outputted from the laser beam direction control unit 34. The high reflection mirror 345 may reflect the combination 32c of the pre-pulse laser beam and the main pulse laser beam at high reflectance, and may cause the combination 32c of the pre-pulse laser beam and the main pulse laser beam to enter the chamber 2 through the window 21 located in a position in front of the reflective surface 231 of the EUV collector mirror 23a. In the chamber 2, the flat mirror 221 and the off-axis paraboloidal mirror 222 may be fixed to the plate 83 fixed to the plate 82 in the position in front of the reflective surface 231 of the EUV collector mirror 23a. The flat mirror 221 and the off-axis paraboloidal mirror 222 may reflect the combination 32c of the pre-pulse laser beam and the main pulse laser beam, and may focus it as the combination 33c of the pre-pulse laser beam and the main pulse laser beam on the plasma generation region 25.

The beam path axes 33a and 33b of the pre-pulse laser beam and the main pulse laser beam focused on the plasma generation region 25 may extend in a −Y direction. The target generation unit 26 may supply a target 27 substantially in the Y direction so that the target 27 is supplied to the plasma generation region 25. However, the target 27 may pass through the plasma generation region 25 without being irradiated with the combination 33c of the pre-pulse laser beam and the main pulse laser beam. The target 27 may be supplied in a direction slightly off the Y direction so that the target 27 does not strike the off-axis paraboloidal mirror 222 in a case where the target 27 has passed through the plasma generation region 25. It should be noted that without being limited to the configuration thus illustrated, the target 27 may be supplied in the X direction.

The central axis 18b of the magnetic field 18a may extend in the X direction. That is, the surface including the beam path axes 33a and 33b and the central axis 18b of the magnetic field 18a may be parallel to the XY plane. The central axis 232 of the EUV collector mirror 23a may extend in the Z direction. Moreover, the reflective surface 231 of the EUV collector mirror 23a may face in the Z direction to face the surface including the beam path axes 33a and 33b and the central axis 18b of the magnetic field 18a.

The other points may be similar to those of the first embodiment.

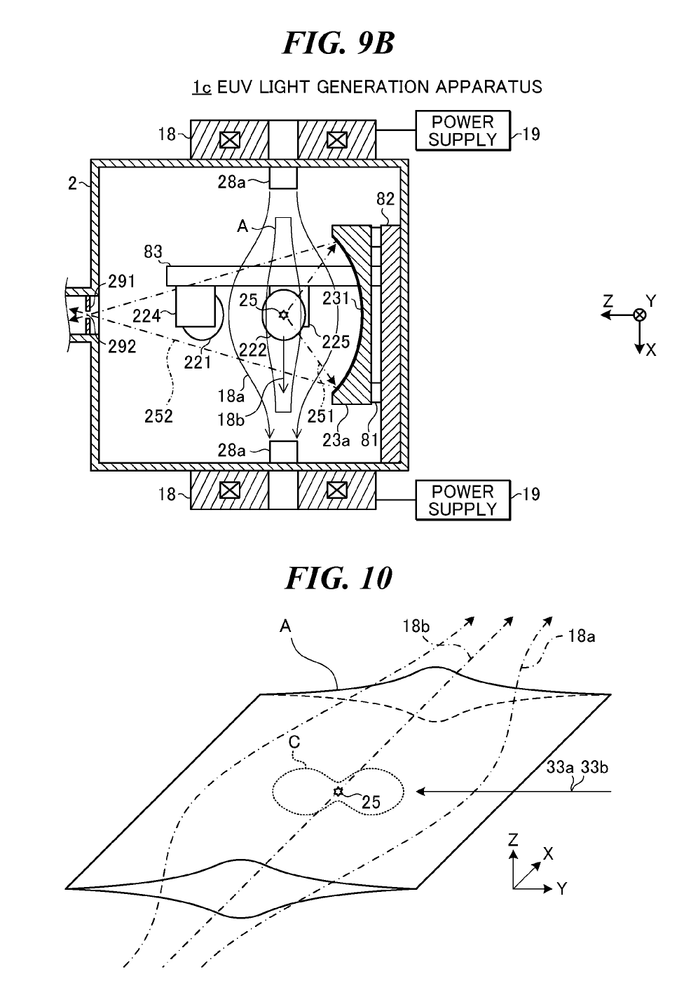

FIG. 10 schematically illustrates a range A of convergence of ions by a magnetic field. While the aforementioned curve C, which represents a distribution of ion charge amounts, applies to a case where the magnetic field generator 18 is shut off from the power supply 19, FIG. 10 shows how the magnetic field 18a causes ions distributed as represented by the curve C to converge. In FIG. 10, the beam path axes 33a and 33b of the pre-pulse laser beam and the main pulse laser beam may be orthogonal to the central axis 18b of the magnetic field 18a.

As shown in FIG. 10, ions of a target material generated in the plasma generation region 25 may converge along the magnetic field 18a, i.e. along the X-axis, into the shape of a band.

Shapes of convergence in directions intersecting with the magnetic field 18a may vary between a direction along the Y-axis and a direction along the Z-axis. Along the Y-axis, which is parallel to the beam path axis 33a of the pre-pulse laser beam and the beam path axis 33b of the main pulse laser beam, the amount of emission of ions is large as represented by the curve C; therefore, the ions easily spread along the Y-axis even when they are caused by the magnetic field 18a to converge. Meanwhile, along the Z-axis, which is perpendicular to the beam path axis 33a of the pre-pulse laser beam and the beam path axis 33b of the main pulse laser beam, the amount of emission of ions is small as represented by the curve C; therefore, the effect of convergence by the magnetic field 18a may be strongly exerted. This may cause the ions to converge into a wide range along the Y-axis and into a narrow range along the Z-axis.

With reference to FIGS. 9A and 9B, the range of ion convergence A shown in FIG. 10 is shown. The arrangement shown in FIGS. 9A and 9B makes it possible to restrain the ions of the target material from scattering onto the reflective surface 231 of the EUV collector mirror 23a. This makes it possible to restrain debris derived from the target material from accumulating on the reflective surface 231 to lower the reflectance of the EUV collector mirror 23a. The ions that were not able to reach the ion collector 28a may be discharged by a discharger (not shown) out of the chamber 2 together with gas in the chamber 2.

### 8. Others

### First Laser Apparatus

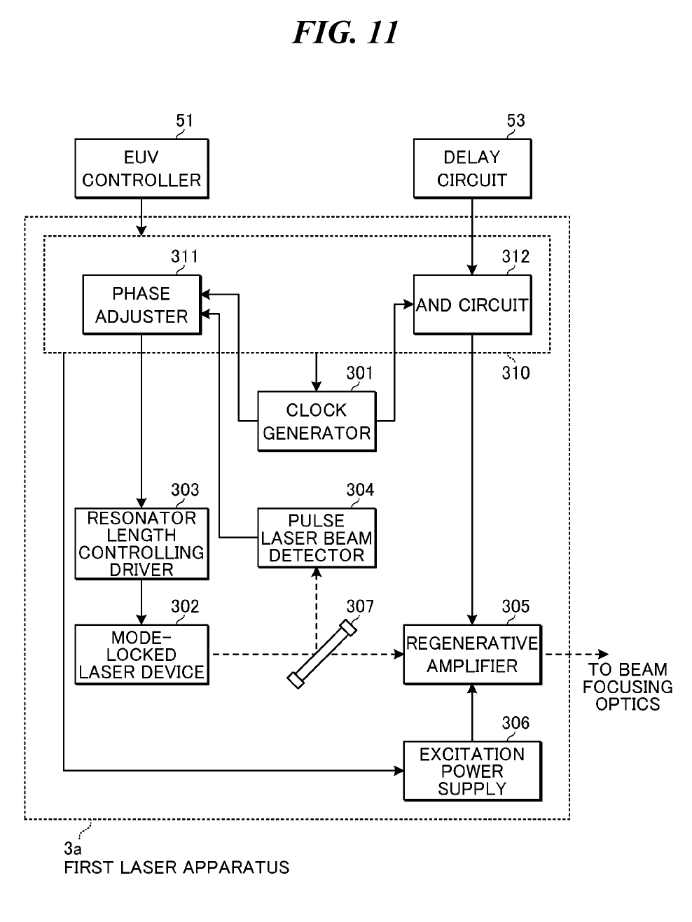

FIG. 11 is a block diagram of a first laser apparatus 3a that can be used in each of the EUV light generation apparatuses according to the aforementioned respective embodiments. The first laser apparatus 3a shown in FIG. 11 may output a pre-pulse laser beam having pulse duration in the picosecond range.

A mode-locked laser device may be used as an apparatus to generate a pulse laser beam having the short pulse duration. The mode-locked laser device may oscillate at a plurality of longitudinal modes with fixed phases with each other. When the plurality of longitudinal modes is combined with each other, a pulse laser beam having short pulse duration may be outputted. However, timing at which a pulse of the pulse laser beam is outputted from the mode-locked laser device may depend on timing at which a preceding pulse is outputted and depend on repetition rate in accordance with resonator length of the mode-locked laser device. Accordingly, it may not be easy to control the mode-locked laser device such that each pulse is outputted at desired timing. In order to achieve timing control of the pre-pulse laser beam with which the droplet target supplied to the chamber is irradiated, the first laser apparatus 3a may have the following configuration.

The first laser apparatus 3a may include a clock generator 301, a mode-locked laser device 302, a resonator length controlling driver 303, a pulse laser beam detector 304, a regenerative amplifier 305, an excitation power supply 306, and a controller 310.

The clock generator 301 may output a clock signal, for example, at a repetition rate of 100 MHz. The mode-locked laser device 302 may output a pulse laser beam having pulse duration in the picosecond range and at a repetition rate of approximately 100 MHz, for example. The mode-locked laser device 302 may include an optical resonator (not shown). The resonator length of the optical resonator may be adjusted through the resonator length controlling driver 303. The adjustment of the resonator length makes it possible to control the repetition rate of the pulse laser beam that is outputted from the mode-locked laser device 302. The repetition rate of the pulse laser beam that is outputted from the mode-locked laser device 302 may be controlled to coincide with the repetition rate of the clock generator 301.

A beam splitter 307 may be provided in a beam path of the pulse laser beam outputted from the mode-locked laser device 302. The pulse laser beam detector 304 may be provided in one of beam paths of the pulse laser beam split by the beam splitter 307. The pulse laser beam detector 304 may be configured to detect the pulse laser beam and output a detection signal.

The regenerative amplifier 305 may be provided in the other of the beam paths of the pulse laser beam split by the beam splitter 307. The regenerative amplifier 305 may include an optical resonator (not shown) in which the pulse laser beam is amplified by traveling back and forth several times. The regenerative amplifier 305 may take out the amplified pulse laser beam at timing when the pulse laser beam has traveled a predetermined number of times in the optical resonator. In the optical resonator of the regenerative amplifier 305, a laser medium may be disposed. Energy for exciting the laser medium may be provided via the excitation power supply 306 to the laser medium. The regenerative amplifier 305 may include a Pockels cell therein.

The controller 310 may include a phase adjuster 311 and an AND circuit 312. The phase adjuster 311 may carry out feedback control on the resonator length controlling driver 303 based on the clock signal from the clock generator 301 and the detection signal from the pulse laser beam detector 304.

Further, the controller 310 may control the regenerative amplifier 305 based on the clock signal from the clock generator 301 and the first or third delay signal from the delay circuit 53 mentioned in reference to FIG. 2A. The AND circuit 312 may generate an AND signal of the clock signal and the first or third delay signal, and control the Pockels cell inside the regenerative amplifier 305 based on the AND signal.

The regenerative amplifier 305 may amplify, to a predetermined intensity, only a pulse which, among the multiple pulses included in the pulse laser beam outputted from the mode-locked laser device 302, is traveling inside the optical resonator of the regenerative amplifier 305 at the timing when the AND signal is applied to the Pockels cell. In this way, the first laser apparatus 3a may amplify, to the predetermined intensity, only a pulse that is to be focused on the plasma generation region 25 at the timing when a target reaches the plasma generation region 25, and may output it as a pre-pulse laser beam. The pulse duration of the pre-pulse laser beam may be in the picosecond range.

Since the pulse duration of the pre-pulse laser beam is in the picosecond range, the target may be reduced to particles to be diffused. This allows the diffused target to be efficiently turned into plasma when irradiated with the main pulse laser beam.

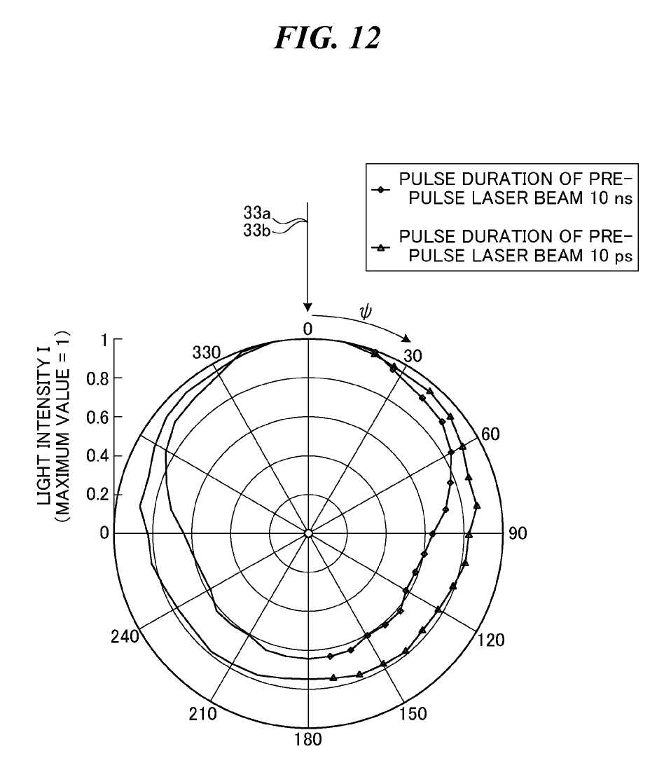

FIG. 12 shows a plane of polar coordinates of a result of measurement of a light intensity distribution of EUV light emitted from plasma. FIG. 12 shows a light intensity distribution as seen from a direction perpendicular to the beam path axes 33a and 33b of the pre-pulse laser beam and the main pulse laser beam. The angle ψ with respect to the upper direction in FIG. 12 represents the angle with respect to the beam path axes 33a and 33b of the pre-pulse laser beam and the main pulse laser beam. The distance from the origin in FIG. 12 represents the light intensity I of EUV light emitted at each angle from the plasma generation region 25.

Used as a target was liquid tin (Sn) having a diameter of 20 μm. The main pulse laser beam had a wavelength of 10.6 μm, a pulse duration of 15 ns, a pulse energy of 150 mJ, and a spot diameter of 300 μm.

A pre-pulse laser beam having pulse duration in the nanosecond range and a pre-pulse laser beam having pulse duration in the picosecond range were each used as the pre-pulse laser beam, and the results were compared. The pre-pulse laser beam having pulse duration in the nanosecond range had a wavelength of 1.06 μm, a pulse duration of 10 ns, a pulse energy of 2.7 mJ, and a spot diameter of 70 μm. The fifth delay time of the timing of the irradiation with the main pulse laser beam from the timing of the irradiation with the pre-pulse laser beam having pulse duration in the nanosecond range was 3 μs.

The pre-pulse laser beam having pulse duration in the picosecond range had a wavelength of 1.06 μm, a pulse duration of 10 μs, a pulse energy of 1 mJ, and a spot diameter of 70 μm. The fifth delay time of the timing of the irradiation with the main pulse laser beam from the timing of the irradiation with the pre-pulse laser beam having pulse duration in the picosecond range was 1.1 μs.

The aforementioned “spot diameter” is the diameter of a portion having an intensity equal to or higher than 1/e² of the peak intensity in the position at which the pulse laser beam is focused. The aforementioned fifth delay time was selected to take on a value at which the highest CE was achieved under each of the pre-pulse laser beam conditions.

The distribution of light intensity of EUV light may be axisymmetrical about the beam path axes 33a and 33b of the pre-pulse laser beam and the main pulse laser beam. That is, when represented in a space of polar coordinates, the distribution of light intensity of EUV light may be in the shape of a curved surface obtained by a trajectory of rotation, about a straight line of ψ=0 deg, of a curve representing a right-half distribution shown in FIG. 12. The straight line of ψ=0 deg may correspond to the beam path axes 33a and 33b of the pre-pulse laser beam and the main pulse laser beam. As shown in FIG. 12, the EUV light was not isotropically generated, but the EUV light varied in intensity between the direction on the upstream side and the direction on the downstream side of the beam path axes of the pre-pulse laser beam and the main pulse laser beam.

Each of the first to fourth embodiments shows a case where the pre-pulse laser beam and the main pulse laser beam are focused on the plasma generation region 25 from the position in front of the reflective surface of the EUV collector mirror 23a. In these embodiments, the uniformity of a far-field pattern of EUV light focused by the EUV collector mirror 23a can be lowered when the EUV light varies in intensity between the direction on the upstream side and the direction on the downstream side of the beam path axes of the pre-pulse laser beam and the main pulse laser beam. However, as shown in FIG. 12, the uniformity of the intensity distribution of the EUV light can be improved in a case where the target is irradiated with the pre-pulse laser beam having pulse duration in the picosecond range.

Further, as shown in FIG. 3, CE can be higher in a case where the pre-pulse laser beam has pulse duration in the picosecond range than in a case where the pre-pulse laser beam has pulse duration in the nanosecond range. Further, the rate of generation of neutral particles having no charge can be decreased in a case where the pre-pulse laser beam has pulse duration in the picosecond range. For this reason, much of the debris can be collected by a magnetic field that is generated by the magnetic field generator 18 and the ion collector 28a.

The descriptions above are intended to be illustrative only and the present disclosure is not limited thereto. Therefore, it will be apparent to those skilled in the art that it is possible to make modifications to the embodiments of the present disclosure within the scope of the appended claims.

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

1. An extreme ultraviolet light generation system comprising:
a first laser apparatus;
a second laser apparatus;
a chamber having a through-hole through which a pre-pulse laser beam outputted from the first laser apparatus and a main pulse laser beam outputted from the second laser apparatus pass;
a magnetic field generator configured to generate a magnetic field in a region including a plasma generation region inside the chamber;
a beam focusing optics configured such that the pre-pulse laser beam and the main pulse laser beam are focused on the plasma generation region and that a beam path axis of the pre-pulse laser beam and a beam path axis of the main pulse laser beam pass through the plasma generation region at an angle equal to or smaller than a loss-cone angle with respect to a central axis of the magnetic field that is generated by the magnetic field generator;
a target generation unit; and
an EUV light generation controller configured to control the first laser apparatus and the second laser apparatus such that, after a target outputted from the target generation unit has been irradiated with the pre-pulse laser beam in the plasma generation region, the target is irradiated with the main pulse laser beam with a delay time ranging from 0.5 μs or longer to 7 μs or shorter.

2. The extreme ultraviolet light generation system according to claim 1,
wherein the beam focusing optics is arranged such that the beam path axis of the pre-pulse laser beam and the beam path axis of the main pulse laser beam extend substantially in a same direction as the central axis of the magnetic field that is generated by the magnetic field generator.

3. An extreme ultraviolet light generation apparatus comprising:
a chamber having a through-hole through which a pulse laser beam passes;
a beam focusing optics configured such that the pulse laser beam is focused on a plasma generation region inside the chamber;
a target generation unit configured to output a target toward the plasma generation region;
a magnetic field generator configured to generate a magnetic field in a region including the plasma generation region; and
an ion collector located between the plasma generation region and the magnetic field generator, configured to collect an ion generated in the plasma generation region, and defining a laser beam passageway through which the pulse laser beam passes.

4. The extreme ultraviolet light generation apparatus according to claim 3,
wherein the ion collector includes:
a power supply; and
a pair of electrodes configured to, when a voltage is applied to the pair of electrodes by the power supply, generate an electric field in a direction intersecting with a direction of the magnetic field.

5. An extreme ultraviolet light generation apparatus comprising:
a chamber having a through-hole through which a pre-pulse laser beam outputted from a first laser apparatus and a main pulse laser beam outputted from a second laser apparatus pass;
a magnetic field generator configured to generate a magnetic field in a region including a plasma generation region inside the chamber;
a target generation unit;
a beam combiner configured to combine the pre-pulse laser beam and the main pulse laser beam;
a beam focusing optics configured such that the pre-pulse laser beam and the main pulse laser beam outputted from the beam combiner are focused on the plasma generation region in such a manner as to intersect with a central axis of the magnetic field that is generated by the magnetic field generator; and
an EUV collector mirror having a reflective surface facing a surface including beam path axes of the pre-pulse laser beam and the main pulse laser beam and the central axis of the magnetic field that is generated by the magnetic field generator, the EUV collector mirror being configured to collect extreme ultraviolet light generated in the plasma generation region.
